(19) United States
(12) Patent Application Publication
(10) Pub. No.: US 2018/0276769 A1
(43) Pub. Date: Sep. 27, 2018

(54) CASHLESS TIPPING METHODS AND APPARATUS

(71) Applicant: MasterCard International Incorporated, Purchase, NY (US)

(72) Inventors: Amy Mizon, Stamford (GB); Robert Ward, Braintree (GB); Debra Bonnington, Peterborough (GB)

(21) Appl. No.: 15/466,043

(22) Filed: Mar. 22, 2017

(51) Int. Cl. G06Q 50/12; G06K 7/14; G06Q 20/32

(52) U.S. Cl. CPC G06Q 50/12; G06Q 20/3276; G06K 7/1417; G06K 7/1413

(57) ABSTRACT

A gratuity is electronically transferred to at least one gratuity recipient. In the gratuity transfer process, a marker item is read. The marker item contains recipient data that identifies the recipient or recipients. A monetary amount for the gratuity is selected by the person giving the gratuity. That person also approves a funds transfer transaction for transferring the monetary amount to the recipient or recipients

### BACKGROUND

Restaurant wait staff typically receive their tips either in cash from patrons or disbursed from a pool by their employer. The wait staff may lose out in cases where the patron has no cash available for a tip, or where the staff member's share from a pool falls short of what the staff member's efforts contributed to the pool.

Moreover, in general, as cash is used less often, those who depend on cash tips may face diminution of their overall compensation. Still further, individuals whose spending habits may omit cash may also face a dilemma when they wish to provide a tip in a situation that has traditionally involved a cash tip.

Another point to be noted is that employers who administer a pool of tips may prefer to be relieved of the associated administrative burdens, assuming that could be accomplished without disadvantaging their staff.

### BRIEF DESCRIPTION OF THE DRAWINGS

Features and advantages of some embodiments of the present disclosure, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram that illustrates a cashless tipping system according to aspects of the present disclosure.

FIG. 2 is a block diagram that illustrates alternative aspects of the cashless tipping system of FIG. 1.

FIG. 3 is a block diagram that shows some features of a typical mobile device that may perform a role in the cashless tipping system illustrated in FIGS. 1 and 2.

FIG. 4 is a block diagram that illustrates a computer system that may perform a role in the cashless tipping system illustrated in FIGS. 1 and 2.

FIGS. 5, 6, 7 and 8 are flow charts that illustrate processes that may be performed in accordance with aspects of the present disclosure.

### DETAILED DESCRIPTION

In general, and to introduce concepts of embodiments of this disclosure, a mobile app running on a mobile device may interact with a remote gratuities server to allow for convenient, cashless and rapid transfers of tips via a payment card account system. So-called P2P (person-to-person) transfers may be part of the process. Identification of the tip recipient may proceed via facial recognition of a registered tip recipient based on a photo of the intended recipient uploaded from the tipper's mobile device. Alternatively, an individual recipient or a group of recipients may be identified by having the tipper's mobile device scan/read a marker item such as a QR code or a wearable electronic device associated with the intended recipient.

A mobile app as proposed herein, with support of a gratuities server and a payment account network, may render cashless tipping highly convenient for tipper, recipient, and employing establishment.

For purposes of this document and the appended claims, the terms “gratuity” and “tip” are synonymous.

A tipper will sometimes be referred to herein as a “sender”, reflecting the tipper's role in a funds transfer transaction that accomplishes the desired cashless tip.

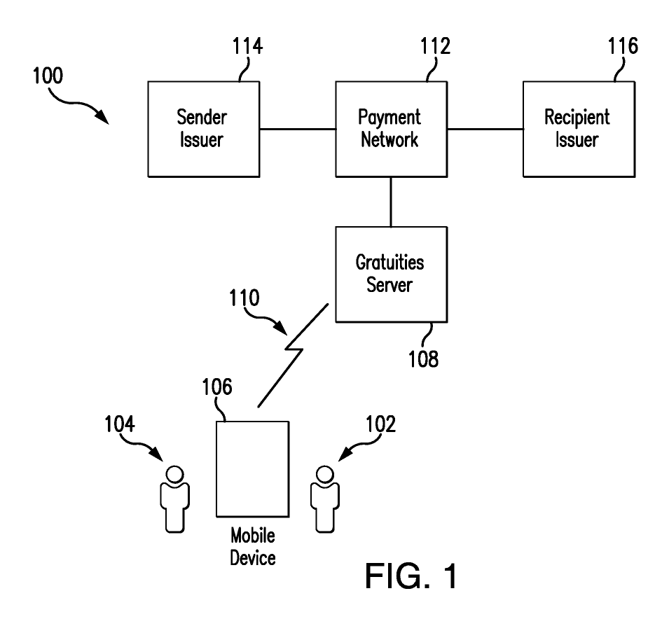

FIG. 1 is a block diagram that illustrates a cashless tipping system 100 according to aspects of the present disclosure.

Reference numeral 102 indicates the tipper. Reference numeral 104 indicates the intended recipient. The tipper 102 carries a mobile device 106 (e.g., a smartphone). It is assumed that, as is commonly the case, the mobile device 106 includes a digital camera.

The tipper 102 and the recipient 104 are shown in proximity to each other, such that the tipper is able to take a photo of or with the recipient 104 using the mobile device 106.

The mobile device 106 is, at least from time to time, in wireless communication with a gratuities server computer 108. The communication channel between the mobile device 106 and the gratuities server computer 108 is schematically represented at 110, and may include portions of a mobile telecommunications network (not separately shown), with which the mobile device is registered.

The gratuities server computer 108 is in communication with a payment network 112. The payment network 112 may be a central component in a payment card account system (generally not shown apart from some aspects of FIG. 1), such as the very well known system operated by Mastercard International Incorporated, which is the assignee hereof. As will be seen, in response to requests from the tipper 102, the gratuities server computer 108 may signal the payment network 112 to arrange for funds transfer transactions to transfer funds from a sender account issuer 114 (issuer of the tipper's payment card account) to a recipient account issuer 116 (issuer of the tip recipient's payment card account), for the benefit of the tip recipient 104, and for charging to the account of the sender/tipper 102.

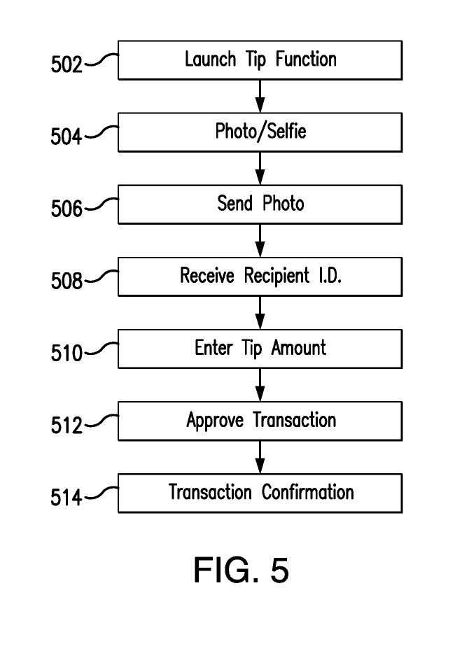

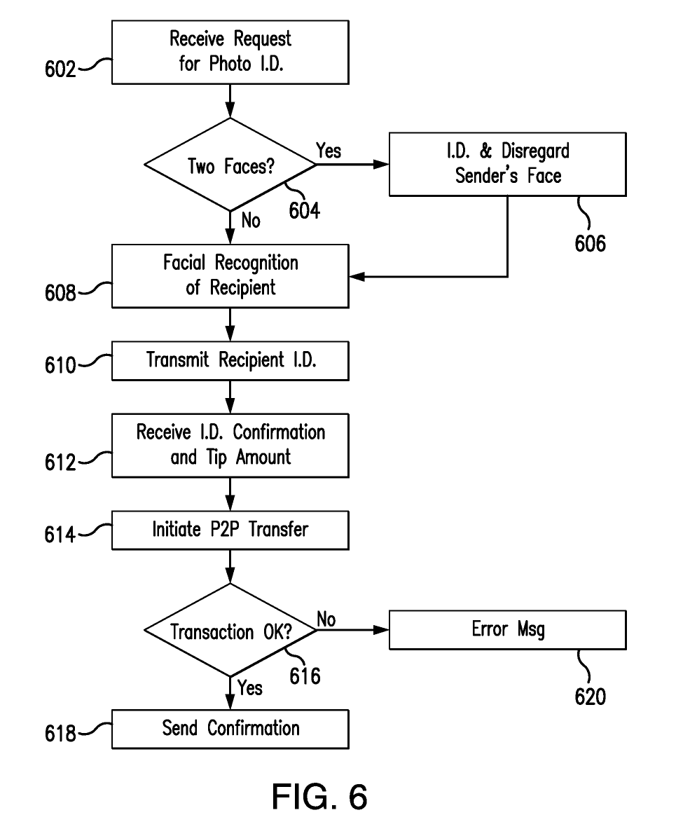

Details of a typical tip transaction in the system 100 will be described below with reference to FIGS. 5 and 6. Blocks that represent entities in FIG. 1 may also, in at least some cases, be deemed to represent one or more computers operated by or on behalf of such entities.

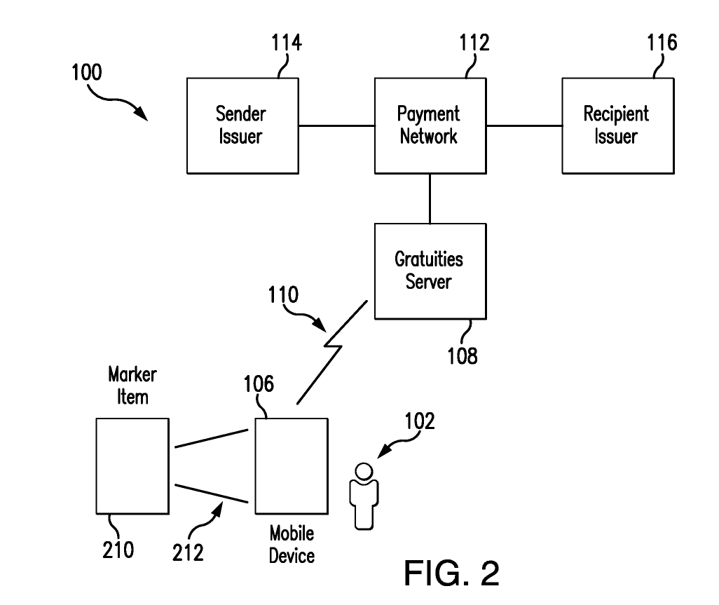

FIG. 2 is a block diagram that illustrates alternative aspects of the cashless tipping system 100 shown in FIG. 1.

According to the illustration of the system 100 in FIG. 2, the tipper 102, mobile device 106, gratuities server computer 108, payment network 112, sender account issuer 114 and recipient account issuer 116 are carried over from the illustration as in FIG. 1. The recipient 104 of FIG. 1 may or may not be present in the situation illustrated in FIG. 2, but in any case is not explicitly represented in FIG. 2.

FIG. 2 also shows a marker item 210. It is schematically depicted at 212 in FIG. 2 that the mobile device 106 reads the marker item in some manner to obtain data that identifies the recipient or a group of recipients to which the intended tip is to be transferred. The manner of reading may, for example, be optical or via short range radio communications such as NFC or RFID (near field communication or radio frequency identification). The marker item may be realized, for example, as a QR code or other barcode printed on paper or another substrate. Alternatively, the marker item may be an electronic device such as a wearable electronic device (e.g., worn by the recipient—who as noted above is not shown in FIG. 2) with radio communication capabilities; or as an RFID tag or badge which may or may not be worn by the recipient.

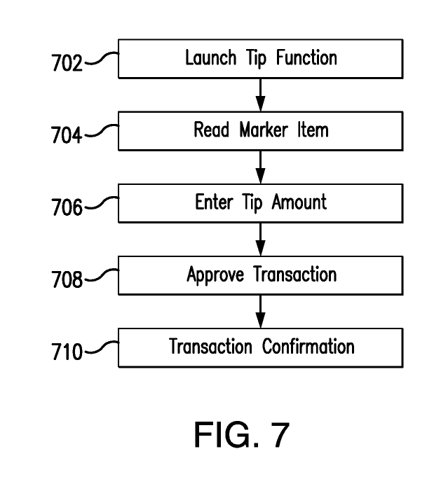

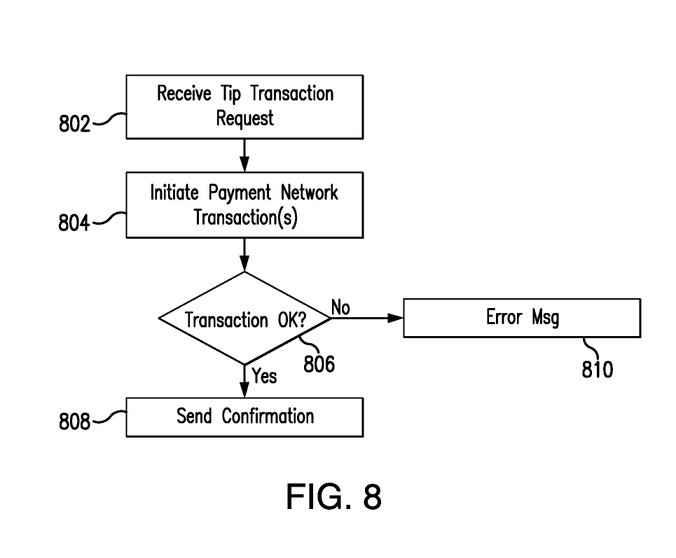

Details of use cases, and of a typical transaction according to the presentation of the system 100 in FIG. 2, will be described below in connection with FIGS. 7 and 8.

As used herein and in the appended claims, the term “marker item” refers to any object, whether or not electronically operative, from which tip recipient identification data may be read by using the mobile device 106.

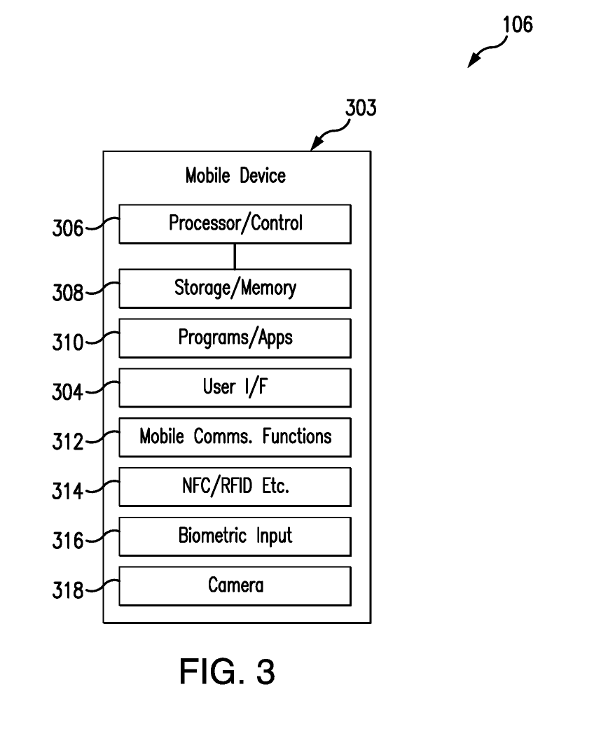

FIG. 3 is a block diagram that shows some features of a typical embodiment of the mobile device 106 shown in FIGS. 1 and 2.

The mobile device 106 may include a housing 303. In many embodiments, the front of the housing 303 is predominantly constituted by a touchscreen (not separately shown), which is a key element of the user interface 304 of the mobile device 106.

The mobile device 106 further includes a mobile processor/control circuit 306, which is contained within the housing 303. Also included in the mobile device 106 is a storage/memory device or devices (reference numeral 308). The storage/memory devices 308 are in communication with the processor/control circuit 306 and may contain program instructions to control the processor/control circuit 306 to manage and perform various functions of the mobile device 106. As is well-known, a device such as mobile device 106 may function as what is in effect a pocket-sized personal computer (assuming for example that the mobile device is a smartphone), via programming with a number of application programs, or “apps”, as well as a mobile operating system (OS). (The apps are represented at block 310 in FIG. 3, and may, along with other programs, in practice be stored in block 308, to program the processor/control circuit 306.) In accordance with aspects of the present disclosure, the apps 310 may include a wallet app or other app that provides functionality so that the mobile device 106 can perform its role or roles in cashless tipping transactions as described herein.

As is typical for mobile devices, the mobile device 106 may include mobile communications functions as represented by block 312. The mobile communications functions may include voice and data communications via a mobile communication network with which the mobile device 106 is registered. The mobile communication functions 312 may operate to allow the mobile device 106 to engage in data communications with the gratuities server computer 108, as described herein.

In addition, to facilitate use for, e.g., reading marker items, the mobile device 106 may include short-range radio communications capabilities (block 314), including for example NFC or RFID reading capabilities.

Like many currently available smartphones, the mobile device 106 may also include a biometric input device 316 (e.g., a fingerprint/thumbprint reader). The biometric input device may be utilized for authenticating the user of the device for the purpose of tipping and/or other financial transactions or for other purposes.

Still further, the mobile device 106 may include a conventional digital camera 318 of the type commonly provided in smartphones or similar devices.

From the foregoing discussion, it will be appreciated that the blocks depicted in FIG. 3 as components of the mobile device 106 may in effect overlap with each other, and/or there may be functional connections among the blocks which are not explicitly shown in the drawing. It may also be assumed that, like a typical smartphone, the mobile device 106 may include a rechargeable battery (not shown) that is contained within the housing 303 and that provides electrical power to the active components of the mobile device 106.

It has been posited that the mobile device 106 may be embodied as a smartphone, but this assumption is not intended to be limiting, as mobile device 106 may alternatively, in at least some cases, be constituted by a tablet computer or by other types of mobile computing devices.

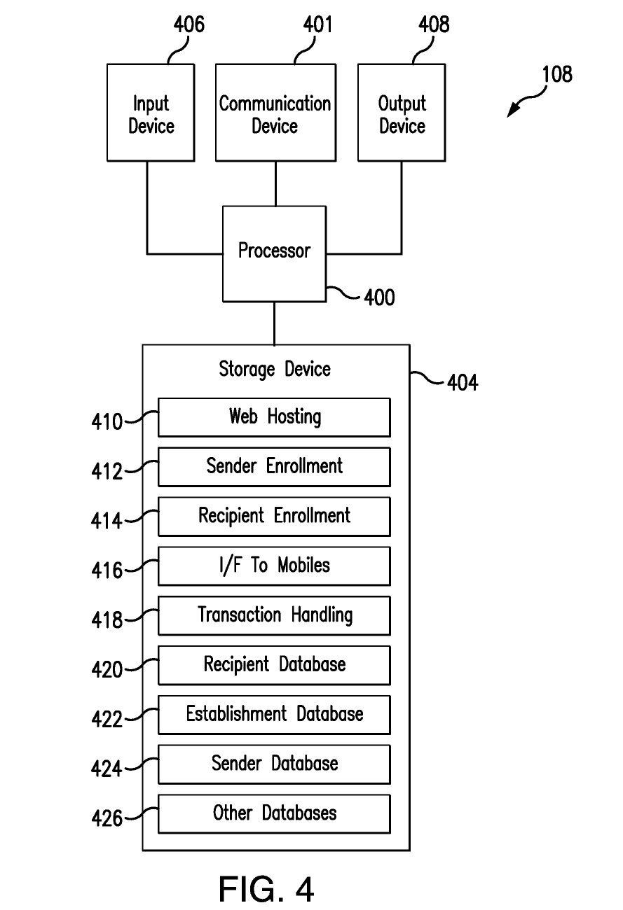

FIG. 4 is a block diagram representation of an embodiment of the gratuities server computer 108 which is shown in FIGS. 1 and 2. The gratuities server computer 108 may be constituted by server computer and/or mainframe computer hardware.

The gratuities server computer 108 may include a computer processor 400 operatively coupled to a communication device 401, a storage device 404, an input device 406 and an output device 408. The computer processor 400 may be in communication with the communication device 401, the storage device 404, the input device 406 and the output device 408.

The computer processor 400 may be constituted by one or more processors. Processor 400 operates to execute processor-executable steps, contained in program instructions described below, so as to control the gratuities server computer 108 to provide desired functionality.

Communication device 401 may be used to facilitate communication with, for example, other devices (such as tippers' mobile devices, and the payment network). For example communication device 401 may comprise numerous communication ports (not separately shown), to allow the gratuities server computer 108 to communicate simultaneously with a large number of other devices and computers, including communications as required to handle numerous tipping transactions as described herein. The communication device 401 and the gratuities server computer 108 may, for example, be configured to simultaneously handle hundreds or thousands of tipping transactions.

Input device 406 may comprise one or more of any type of peripheral device typically used to input data into a computer. For example, the input device 406 may include a keyboard and a mouse. Output device 408 may comprise, for example, a display and/or a printer.

Storage device 404 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 404 stores one or more programs for controlling processor 400. The programs comprise program instructions (which may be referred to as computer readable program code means) that contain processor-executable process steps of the gratuities server computer 108, executed by the processor 400 to cause the gratuities server computer 108 to function as described herein.

The programs stored by the storage device 404 may include one or more operating systems (not shown) that control the processor 400 so as to manage and coordinate activities and sharing of resources in the gratuities server computer 108, and to serve as a host for application programs that run on the gratuities server computer 108.

The storage device 404 may also store a web hosting application program 410 that programs the processor 400 to enable the gratuities server computer 108 to host a website whereby users such as senders and recipients may access and interact with the gratuities server computer 108.

The storage device 404 may further store a sender enrollment application program 412. The sender enrollment application program 412 may control the processor 400 to enable the gratuities server computer 108 to permit prospective users of the system 100 as tippers to open user accounts on the gratuities server computer 108. To open such a user account as a tipper, the individual in question may be required to enter his/her name and contact information. In some embodiments, payment account information may also be required to be entered, although alternatively this information may be provided at the time of each tipping transaction (e.g., from the wallet app in the tipper's mobile device). For reasons that will become clear from subsequent discussion, the tipper/user information to be supplied to the gratuities server computer 108 may also include one or more “head shots” (i.e., photo or photos, formal or informal) showing the tipper/user's face.

The storage device 404 may in addition store a tip recipient enrollment application program 414. The recipient enrollment application program 414 may control the processor 400 to enable the gratuities server computer 108 to permit prospective tip recipients to open user accounts on the gratuities server computer 108. To open a recipient account, the individual may be required to enter his/her name and contact information. Further, it may be most efficient if the enrollment of the recipient also includes payment account information for the recipient to facilitate routing of tips to the recipient's payment account via the payment card account system. It may also be required that the recipient enter tax identification information to support the compliance of the gratuities server computer 108 with tax withholding/reporting requirements, or the like. It may also be the case for recipient/users that they be required to supply a photo or photos of their faces to the gratuities server computer 108.

Moreover, the storage device 404 may store a software interface 416 that supports communication between the gratuities server computer 108 and mobile devices utilized by senders to initiate tipping transactions.

Still further, the storage device 404 may store a transaction handling application program 418. The transaction handling application program 418 may control the processor 400 to enable the gratuities server computer 108 to handle tipping transactions as described herein.

The storage device 404 may further store database management programs and an internal reporting application (both not separately shown), the latter of which may respond to requests from computer system administrators for reports on the activities performed by the gratuities server computer 108; the storage device 404 may also store communication software, device drivers, etc.

The storage device 404 may also store a recipient database 420, an establishment database 422, a sender database 424, and one or more other databases 426 required for operation of the gratuities server computer 108. The recipient database 420 may contain data records for the tip recipients who have signed up with the gratuities server computer 108. The establishment database 422 may store data records for business establishments or other establishments that employ potential recipients of tips in the tipping system 100. The sender database 424 may store data records for tippers who have signed up with the gratuities server computer 108.

Other computers that play a part in the tipping system 100 may be similar in their hardware architecture and in their constituent hardware components to the gratuities server computer 108 as just described. Such other computers may be programmed with different programs from those described above.

FIG. 5 is a flow chart that illustrates a process that may be performed according to aspects of the present disclosure. As a brief overview, the process of FIG. 5 facilitates rapid and convenient identification of a tip recipient by facial recognition processing. The process of FIG. 5 represents functions performed at or by a mobile device 106, as depicted in FIG. 1.

At block 502 in FIG. 5, the user/tipper 102 may interact with the mobile device 106 to call up a tipping function provided by the mobile device 106. In some embodiments, the tipping function may be one functional option available via a wallet app that runs on the mobile device 106. In other embodiments, the tipping function may be provided by another app (such as a payment app, or a dedicated tipping app).

At block 504, the tipper 102 may use the camera component of the mobile device 106 to take a photograph (digital image) of the tip recipient 104. In some situations, the photo may be a so-called “selfie” with images of the faces of both the tipper and the recipient captured in the image. Selfies of this kind (i.e., including the mobile device owner and one or more other people) are well known. In this situation, the image generation and storage components of the mobile device 106 may be in communication with or under control of the tipping function, such that the photo (selfie or not) is made available to the app that provides the tipping function.

At block 506, the mobile device 106/tipping function may transmit the photo to the gratuities server computer 108 for identification of the recipient by the gratuities server computer 108. The transmission of the photo may include or be associated with data from the mobile device 106 that identifies the tipper to the gratuities server computer 108.

At block 508, the mobile device 106/tipping function receives back from the gratuities server computer 108 data that identifies the recipient (e.g., by first and/or last name, employing establishment, geographic location, etc.) At least some of this information may be displayed by the mobile device 106 to the tipper, so that the tipper can confirm that the intended recipient has been properly identified by the gratuities server computer 108.

At 510, the tipper may interact with the mobile device 106 to enter the monetary amount of the tip that the tipper desires to transfer to the recipient. (It will be appreciated, as discussed below, that the order in which these steps occur may vary, such that, for example, the tip amount may have been entered, e.g., before taking the photo, before sending the photo, etc.)

At 512, the tipper may actuate a virtual button on the mobile device such as one bearing the label “Transfer Tip”, to indicate the tipper's approval and to indicate that the tipping transaction should proceed to consummation. A corresponding signal/indication may then be transmitted from the mobile device 106 to the gratuities server computer 108.

A short time after, and as indicated at 514, the mobile device 106 may receive a confirmation message from the gratuities server computer 108 to confirm that the funds transfer implementing the desired tip has taken place. The confirmation may be displayed to the tipper by the mobile device 106.

The scenario as described in connection with FIG. 5 may take place in connection with any one or more of numerous situations in which cash tips are rendered in customary current usage. For example, this may occur at the end of a meal in a restaurant when the server presents the check (or returns with a payment card slip to be signed by the patron/tipper). As another example, this may occur at the door of a hotel when the doorman or bellhop has just assisted the hotel guest/tipper with some luggage. As still another example, this may occur at a valet parking station, when the parking attendant has returned the tipper's vehicle to the valet parking station so that the tipper can drive away.

FIG. 6 is a flow chart that illustrates a process that may be performed according to aspects of the present disclosure. The process of FIG. 6 represents functions performed at or by the gratuities server computer 108 in relation to the operations of the mobile device 106 as described above in connection with FIG. 5.

At block 602 in FIG. 6, the gratuities server computer 108 receives the request for identification of the tip recipient that was effectively transmitted from the mobile device 106 at 506 in FIG. 5. As understood from discussion of FIG. 5, the request received at 602 includes a photo that shows the face of the intended tip recipient. The request also includes data that identifies the tipper.

In FIG. 6, a decision block 604 may follow block 602. At decision block 604, and based on an analysis of the submitted image, it is determined whether two human faces are shown in the image. If so, then block 606 may follow decision block 604.

For purposes of block 606, it is assumed that a photo (or more than one photo) of the tipper has been stored for the tipper in the tipper's data record in the sender database 424 (FIG. 4). Using essentially conventional facial recognition techniques, the gratuities server computer 108 may compare the two facial images in the submitted photo with the tipper's photo(s) on record to determine which of the two faces belongs to the tipper. Upon identifying one of the two face images in the submitted photo as the tipper's, that identified one of the face images is disregarded in terms of subsequent facial recognition processing to identify the recipient.

Referring again to decision block 604 in FIG. 6, if a negative determination is made at decision block 604 (i.e., if it is determined that there is only one facial image in the submitted photo), then block 608 may follow decision block 604 in the process of FIG. 6. Alternatively, if the process had branched from decision block 604 to block 606, then block 608 may follow block 606.

At block 608, the gratuities server computer 108 performs a facial recognition process with respect to the submitted photo in order to identify the intended tip recipient. If one face is shown in the photo, then facial recognition processing is performed, using registered recipient's photos stored in the recipient database 420 (FIG. 4), to match the face in the submitted photo with one of the recipient records in the recipient database 420. If two faces are in the submitted photo, then the face not disregarded at 606 is used for the recipient identification via facial recognition. Assuming the matching via facial recognition is successful, the recipient's identity, etc., are retrieved from the matching recipient record in the recipient database 420.

Continuing to refer to FIG. 6, block 610 may follow block 608. At block 610, the gratuities server computer 108 may transmit the recipient identification data retrieved at 608 to the tipper's mobile device 106.

Thereafter, block 612 may follow. At block 612, the gratuities server computer 108 receives, from the mobile device 106, the intended tip amount and the tipper's confirmation of the recipient's identity and request that the tip transaction (funds transfer) be initiated. This block 612 corresponds to receipt of the transaction approval transmitted at 512 in FIG. 5.

Continuing to refer to FIG. 6, block 614 may follow block 612. At block 614, the gratuities server computer 108 communicates with the payment network 112 (FIG. 1) to cause a person to person (P2P) funds transfer of the tip amount to be performed for the benefit of the recipient, and charged to the tipper's payment account. This transfer may involve a “pull” of the tip amount from the tipper's payment account (at issuer 114) and a “push” of the amount to the recipient's payment account (at issuer 116).

A decision block 616 may follow block 614 in the process of FIG. 6. At decision block 616, the gratuities server computer 108 may determine whether the tip funds transfer transaction occurred successfully. For example, the gratuities server computer 108 may make this determination based on one or more signals received by the gratuities server computer 108 from the payment network 112.

If a positive determination is made at decision block 616 (i.e., if the gratuities server computer 108 determines that the tip funds transfer transaction occurred successfully), then block 618 may follow decision block 616. At block 618, the gratuities server computer 108 may send a confirmation message to the mobile device 106. This message corresponds to the confirmation referred to at 514 in FIG. 5.

If a negative determination is made at decision block 616, then block 620 may follow decision block 616. At block 620, the gratuities server computer 108 may transmit a suitable error message to the mobile device 106.

FIG. 7 is a flow chart that illustrates a process that may be performed according to aspects of the present disclosure. As a brief overview, the process of FIG. 7 facilitates rapid and convenient identification of a tip recipient by using a mobile device to read recipient identification information from an electronic device, a printed barcode, etc. The process of FIG. 7 represents functions performed at or by a mobile device 106, as depicted in FIG. 2.

At block 702 in FIG. 7, the user/tipper 102 may interact with the mobile device 106 to call up a tipping function provided by the mobile device 106, in a similar manner as described above in connection with block 502 in FIG. 5.

At block 704, the user/tipper 102 may use the mobile device to read the tip recipient identifying information from the marker item 210, as discussed in connection with FIG. 2. For example, if the marker item is a printed barcode (e.g., a QR code), then the mobile device camera may be used to scan the marker item to extract the recipient identification information therefrom. In some situations, the recipient identification information may identify a particular individual as the intended tip recipient. In other situations, the recipient information may identify a group of individuals (say a service department in an establishment) as the intended recipient of a tip which is to be pooled. In one example of the latter, a guest in a hotel room may observe a printed card with a QR code with a suggestion that the guest provide a tip to be pooled/shared among the cleaning staff of the hotel. The QR code in this instance may identify the establishment and the recipient department thereof, namely the cleaning staff.

In other situations, the mobile device 106 may read the recipient information from an electronic device serving as the marker item. For example, in the hotel guest situation the staff tip card/marker item may include an RFID tag to be read by the mobile device 106 to extract the recipient identification information. Again in this instance the recipient identification information may identify the tip recipient group as the cleaning staff department of the hotel establishment.

In still other situations, the marker item may be a wearable electronic device (e.g., badge or wristband) worn by an individual who either is herself/himself the intended recipient identified by information readable from the marker item, or who is a member of a group of recipients identified by information readable from the marker item. The mode of reading may be via RFID, NFC, or any other suitable short-range radio communication.

The marker item may include not just data that identifies the recipient, but also may serve as a command to start the tipping app/tipping function. So it may work like this. The user/tipper 102 may use the mobile device to read the marker item. A code and/or other data or digitally-readable material on the marker item is interpreted in such a way that the mobile device starts the tipping function and then transfers the recipient ID to the tipping function. Then the tipper/user may enter the amount of the tip and confirm/approve the transaction.

Turning to other situations, the individual to be tipped may carry a mobile device (not explicitly shown in FIG. 2) with which the tipper's mobile device 106 may communicate on a short-range radio communications basis to read the recipient information from the recipient's mobile device by the tipper's mobile device 106. In this instance, the recipient's mobile device may be regarded as the “marker item”. For example, a suitable “bump” action with the two mobile devices (with appropriate apps open in each device) may allow for the reading of the recipient information by the tipper's mobile device 106. As another alternative, the recipient's mobile device may display a QR code to be read by the tipper's mobile device.

Once the tipper's mobile device 106 has read the recipient information, it may display the information or a suitable subset thereof to the tipper 102.

At block 706, the tipper may interact with the mobile device 106 to enter the monetary amount of the tip that the tipper desires to transfer to the recipient. (It will be appreciated, as discussed below, that the order in which these steps occur may vary, such that, for example, the tip amount may have been entered, e.g., before reading the recipient information.)

At block 708, the tipper may actuate a virtual button on the mobile device such as one bearing the label “Transfer Tip”, to indicate the tipper's approval and to indicate that the tipping transaction should proceed to consummation. A corresponding signal/indication may then be transmitted from the mobile device 106 to the gratuities server computer 108. The signal may contain recipient identification information as well as data indicative of the desired tip amount.

A short time after, and as indicated at 710, the mobile device 106 may receive a confirmation message from the gratuities server computer 108 to confirm that the funds transfer implementing the desired tip has taken place. The confirmation may be displayed to the tipper by the mobile device 106.

FIG. 8 is a flow chart that illustrates a process that may be performed according to aspects of the present disclosure. The process of FIG. 8 represents functions performed at or by the gratuities server computer 108 in relation to the operations of the mobile device 106 as described above in connection with FIG. 7.

At block 802, the gratuities server computer 108 receives, from the mobile device 106, the intended tip amount, the recipient identification information and the tipper's request that the tip transaction (funds transfer) be initiated. This block 802 corresponds to receipt of the transaction approval/request transmitted at 708 in FIG. 7.

Block 804 may follow block 802. At block 804, the gratuities server computer 108 communicates with the payment network 112 (FIG. 1) to cause a funds transfer of the tip amount to be performed for the benefit of the identified recipient or group of recipients, with the funds transfer to be charged to the tipper's payment account. This transfer may involve a “pull” of the tip amount from the tipper's payment account (at issuer 114) and a “push” of the amount to the recipient's payment account (at issuer 116), or to the employing establishment's pooled tip account for the identified group of recipients.

A decision block 806 may follow block 804 in the process of FIG. 8. At decision block 806, the gratuities server computer 108 may determine whether the tip funds transfer transaction occurred successfully. For example, the gratuities server computer 108 may make this determination based on one or more signals received by the gratuities server computer 108 from the payment network 112.

If a positive determination is made at decision block 806 (i.e., if the gratuities server computer 108 determines that the tip funds transfer transaction occurred successfully), then block 808 may follow decision block 806. At block 808, the gratuities server computer 108 may send a confirmation message to the mobile device 106. This message corresponds to the confirmation referred to at 710 in FIG. 7.

If a negative determination is made at decision block 806, then block 810 may follow decision block 806. At block 810, the gratuities server computer 108 may transmit a suitable error message to the mobile device 106.

Like the processes of FIGS. 5 and 6, the processes of FIGS. 7 and 8 may provide a convenient way for an individual to engage in a cashless tipping transaction. Both of these processes may leverage the existing infrastructure of a widely used payment card account network. In some embodiments, the gratuities server computer 108 may be under common operation with the payment network 112.

As used herein and in the appended claims, the term “computer” should be understood to encompass a single computer or two or more computers in communication with each other.

As used herein and in the appended claims, the term “processor” should be understood to encompass a single processor or two or more processors in communication with each other.

As used herein and in the appended claims, the term “memory” should be understood to encompass a single memory or storage device or two or more memories or storage devices.

As used herein and in the appended claims, a “server” includes a computer device or system that responds to numerous requests for service from other devices.

The flow charts and descriptions thereof herein should not be understood to prescribe a fixed order of performing the method steps described therein. Rather, the method steps may be performed in any order that is practicable, including simultaneous performance of at least some steps.

As used herein and in the appended claims, the term “payment card system account” includes a credit card account, a deposit account that the account holder may access using a debit card, a prepaid card account, or any other type of account from which payment transactions may be consummated. The terms “payment card system account” and “payment card account” and “payment account” are used interchangeably herein. The term “payment card account number” includes a number that identifies a payment card system account or a number carried by a payment card, or a number that is used to route a transaction in a payment system that handles debit card and/or credit card transactions. The term “payment card” includes a credit card, debit card, prepaid card, or other type of payment instrument, whether an actual physical card or virtual.

As used herein and in the appended claims, the term “payment system” refers to a system for handling purchase transactions and related transactions. An example of such a system is the one operated by MasterCard International Incorporated, the assignee of the present disclosure. In some embodiments, the term “payment system” may be limited to systems in which member financial institutions issue payment accounts to individuals, businesses and/or other organizations.

Although the present disclosure has been described in connection with specific exemplary embodiments, it should be understood that various changes, substitutions, and alterations apparent to those skilled in the art can be made to the disclosed embodiments without departing from the spirit and scope of the disclosure as set forth in the appended claims.

What is claimed is:

1. A method of electronically transferring a gratuity to at least one recipient, the method comprising:
reading a marker item, said marker item containing recipient data that identifies the at least one recipient;
selecting a monetary amount for the gratuity; and
approving a funds transfer transaction for transferring said selected monetary amount to said at least one recipient.

2. The method of claim 1, wherein the marker item is read optically.

3. The method of claim 2, wherein the marker item is a barcode.

4. The method of claim 3, wherein the marker item is a QR code.

5. The method of claim 1, wherein the marker item is read by short-range radio communication.

6. The method of claim 5, wherein the marker item is a wearable electronic device.

7. The method of claim 6, wherein the marker item is an electronic badge.

8. The method of claim 6, wherein the marker item is a smartwatch or electronic wristband.

9. The method of claim 5, wherein the marker item is a smartphone.

10. A method of electronically transferring a gratuity to a recipient, the method comprising:
receiving a photographic image of the recipient;
using the image to identify the recipient from among a roster of registered gratuity recipients; and
executing a funds transfer transaction for transferring the gratuity to the identified recipient.

11. The method of claim 10, further comprising:
transmitting identification data regarding the identified recipient to a sender of the gratuity; and
receiving confirmation of the identified recipient from the sender.

12. The method of claim 11, wherein the identification data identifies an establishment where the recipient is employed.

13. The method of claim 10, further comprising:
receiving from a sender of the gratuity, an indication of a monetary amount of the gratuity;
wherein said executing step includes transferring said indicated monetary amount from the sender to the recipient.

14. The method of claim 10, wherein:
the photographic image includes an image of a sender of the gratuity together with an image of the recipient.

15. The method of claim 14, further comprising:
using facial recognition processing to identify the image of the sender, said facial recognition processing including retrieving a reference image of the sender, said reference image of the sender having been stored prior to the receiving step.

16. A method of electronically transferring a gratuity to a recipient, the method comprising:
using a mobile device to capture a photographic image of the recipient;
transmitting the photographic image of the recipient to a gratuities server computer;
selecting a monetary amount for the gratuity; and
approving a funds transfer transaction for transferring said selected monetary amount to said recipient.

17. The method of claim 16, further comprising:
launching a gratuity function on the mobile device.

18. The method of claim 17, wherein the launching step occurs before capturing the photographic image of the recipient.

19. The method of claim 17, wherein the launching step occurs after capturing the photographic image of the recipient.

20. The method of claim 16, further comprising:
receiving identification data regarding the recipient from the gratuities server computer; and
transmitting, to the gratuities server computer, confirmation of said received identification data.
